(19) United States
(12) Patent Application Publication
(10) Pub. No.: US 2025/0377667 A1
(43) Pub. Date: Dec. 11, 2025

(54) NAVIGATION METHOD, DEVICE AND STORAGE MEDIUM IN MULTI-AGENT ENVIRONMENT

(71) Applicant: Beijing Youzhuju Network Technology Co., Ltd., Pinggu District (CN)

(72) Inventors: Yansheng WANG, Beijing (CN); Yangang ZHANG, Beijing (CN)

(21) Appl. No.: 19/038,609

(22) Filed: Jan. 27, 2025

(30) Foreign Application Priority Data
Jun. 6, 2024 (CN) 202410732759.2

(51) Int. Cl. G05D 1/69; G05D 1/246; G05D 101/15; G05D 111/67

(52) U.S. Cl. CPC G05D 1/69; G05D 1/246; G05D 2101/15; G05D 2111/67

(57) ABSTRACT

Embodiments of the present application provide a navigation method, an apparatus, a device and a storge medium in a multi-agent environment, by acquiring navigation log data of a plurality of robots within a target time period; parsing the navigation log data to obtain historical navigation data of N frames of each robot, the historical navigation data including a robot pose, a local map and a navigation planned path; determining one first target robot from the plurality of robots, and fusing the historical navigation data of the plurality of robots to obtain the multi-agent environment by taking the first target robot as an ego perspective, the multi-agent environment including a global map of N frames and poses of a plurality of agents in the global map of N frames, where each robot corresponds to one agent; and performing a multi-agent navigation in the multi-agent environment to execute a multi-agent task.

### CROSS-REFERENCE TO RELATED APPLICATION

The present application claims the priority to and benefits of the Chinese Patent Application No. 202410732759.2, which was filed on Jun. 6, 2024. All the aforementioned patent applications are hereby incorporated by reference in their entireties.

### TECHNICAL FIELD

Embodiments of the present application relate to a field of robot navigation, and in particularly to a navigation method, a device and a storage medium in a multi-agent environment.

### BACKGROUND

The multi-agent environment for mobile navigation tasks is a virtual platform for testing and optimizing a mobile robot navigation technology. The multi-agent environment can simulate various complex scenarios and conditions in the real world, allowing researchers to conduct in-depth research on navigation algorithms, path planning and the like, without the need for actual robot hardware.

At present, most multi-agent environments for mobile navigation tasks are only for a single agent, while for multi-robot navigation simulation scenarios, the multi-agent environments are randomly generated environments. The randomly generated multi-agent environment may be far different from a real physical environment, resulting in unsatisfactory simulation results.

### SUMMARY

Embodiments of the present application provide a navigation method, an apparatus, a device and a storage medium in a multi-agent environment. A multi-agent environment of a plurality of robots is constructed based on actual navigation logs of a large number of robots. The multi-agent environment is generated based on real data, so that the constructed multi-agent environment is more real, thereby causing execution results of multi-agent tasks based on the multi-agent environment more accurate.

In a first aspect, embodiments of the present disclosure provide a navigation method in a multi-agent environment, and the method includes:
acquiring navigation log data of a plurality of robots within a target time period;
parsing the navigation log data to obtain historical navigation data of N frames of each robot, the historical navigation data including a robot pose, a local map and a navigation planned path;
determining one first target robot from the plurality of robots, and fusing the historical navigation data of the plurality of robots to obtain the multi-agent environment by taking the first target robot as an ego perspective, the multi-agent environment including a global map of N frames and poses of a plurality of agents in the global map of N frames, where each robot corresponds to one agent; and
performing a multi-agent navigation in the multi-agent environment to execute a multi-agent task.

In some embodiments, the method further includes:
using a new navigation policy to replace a historical navigation policy of a target agent corresponding to a second target robot in the plurality of robots, and using agents corresponding to the plurality of robots to infer in the multi-agent environment to obtain an inference result, the inference result including a new navigation trajectory of the target agent, and the historical navigation policy being a navigation policy used by the second target robot to generate the historical navigation data.

In some embodiments, where the using agents corresponding to the plurality of robots to infer in the multi-agent environment to obtain an inference result, includes:
taking an initial value of the target agent as an input of the new navigation policy, using the new navigation policy to perform an inference of M steps in the multi-agent environment, to obtain the new navigation trajectory of the target agent, the initial value of the target agent including inference start time, an inference start position and a destination; and
controlling other agents to operate in the multi-agent environment according to historical navigation trajectories of corresponding robots, where the other agents are agents corresponding to remaining robots in the plurality of robots except the second target robot.

In some embodiments, the method further includes:
displaying following content in real time in the multi-agent environment during an inference process: a new position of the target agent, a historical position of the target agent, a new planned path of the target agent, and historical positions of the other agents, where the new position is a navigation position inferred according to the new navigation policy, the historical position is a position indicated by the historical navigation data at a same time, and the new planned path is a path inferred according to the new navigation policy.

In some embodiments, where the using agents corresponding to the plurality of robots to infer in the multi-agent environment to obtain an inference result, includes:
taking an initial value of the target agent as an input of the new navigation policy, using the new navigation policy to perform an inference of M1 steps in the multi-agent environment, to obtain the new navigation trajectory of the target agent, the initial value of the target agent including inference start time, an inference start position and a destination; and
using the new navigation policy to replace historical navigation policies of other agents, taking initial values of the other agents as input of the new navigation policy, using the new navigation policy to perform an inference of M2 steps in the multi-agent environment, to obtain new navigation trajectories of the other agents, the initial values of the other agents including inference start time, an inference start position and a destination.

In some embodiments, the method further includes: displaying following content in real time in the multi-agent environment during an inference process: a new position of the target agent, a historical position of the target agent, a new planned path of the target agent, new positions of the other agents, and historical positions of the other agents, where the new position is a position inferred according to the new navigation policy, the historical position is a position indicated by the historical navigation data at a same time, and the new planned path is a path inferred according to the new navigation policy.

In some embodiments, where the performing a multi-agent navigation in the multi-agent environment to execute a multi-agent task, includes:
training a navigation policy to be trained in the multi-agent environment by using a reinforcement learning method or an imitation learning method.

In some embodiments, where the performing a multi-agent navigation in the multi-agent environment to execute a multi-agent task, includes:
performing navigation playback by the agents corresponding to the plurality of robots according to historical navigation trajectories of the plurality of robots in the multi-agent environment.

In some embodiments, where the fusing the historical navigation data of the plurality of robots to obtain the multi-agent environment by taking the first target robot as an ego perspective, includes:
aligning historical navigation data of each frame of the plurality of robots;
fusing local maps of N frames of the plurality of robots to obtain a global map of each frame; and
determining poses of other robots in the global map according to historical navigation data of the other robots by taking a pose of the first target robot in the global map of each frame as a reference.

In some embodiments, where the new navigation policy is a policy obtained by a reinforcement learning method or an imitation learning method.

In some embodiments, the method further includes:
displaying, in real time, positions of the agents corresponding to the plurality of robots in the multi-agent environment during an inference process.

In some embodiments, the method further includes:
evaluating the new navigation policy by comparing the new navigation trajectory of the target agent and a historical navigation trajectory of the target agent.

In some embodiments, the method further includes:
comparing the new navigation trajectory of the target agent and a historical navigation trajectory of the target agent to evaluate the new navigation policy, to obtain a first evaluation result;
comparing new navigation trajectories of the other agents and historical navigation trajectories of the other agent to evaluate the new navigation policy, to obtain a second evaluation result; and
evaluating the new navigation policy according to the first evaluation result and the second evaluation result.

In a second aspect, embodiments of the present disclosure provide a navigation apparatus in a multi-agent environment, the apparatus includes:
an acquiring module, which is configured to acquire navigation log data of a plurality of robots within a target time period;
a parsing module, which is configured to parse the navigation log data to obtain historical navigation data of N frames of each robot, the historical navigation data including a robot pose, a local map and a navigation planned path;
a fusing module, which is configured to determine one first target robot from the plurality of robots, and fuse the historical navigation data of the plurality of robots to obtain the multi-agent environment by taking the first target robot as an ego perspective, the multi-agent environment including a global map of N frames and poses of a plurality of agents in the global map of N frames, where each robot corresponds to one agent;
an executing module, which is configured to perform a multi-agent navigation in the multi-agent environment to execute a multi-agent task.

In a third aspect, embodiments of the present disclosure provide an electronic device, the electronic device includes: at least one processor and a memory, where the memory is configured to store a computer program, and the at least one processor is configured to invoke and run the computer program stored in the memory to implement the method as described in the first aspect above.

In a fourth aspect, embodiments of the present disclosure provide a non-transitory computer-readable storage medium, configured to store a computer program, the computer program causing a computer to execute the method as described in the first aspect above.

In a fifth aspect, embodiments of the present disclosure provide a computer program product including a computer program, the computer program when executed by a processor implementing a method as described in the first aspect above.

The method, the apparatus, the device and the storage medium for navigation in a multi-agent environment provided by the embodiments of the present application, are implemented by acquiring navigation log data of a plurality of robots within a target time period; parsing the navigation log data to obtain historical navigation data of N frames of each robot, the historical navigation data including a robot pose, a local map and a navigation planned path; determining one first target robot from the plurality of robots, and fusing the historical navigation data of the plurality of robots to obtain the multi-agent environment by taking the first target robot as an ego perspective, the multi-agent environment including a global map of N frames and poses of a plurality of agents in the global map of N frames, where each robot corresponds to one agent; and performing a multi-agent navigation in the multi-agent environment to execute a multi-agent task.

In the method, the multi-agent environment of a plurality of robots is constructed based on actual navigation logs of a large number of robots. The multi-agent environment is generated based on real data, so that the constructed multi-agent environment is more real, thereby causing the execution results of the multi-agent tasks based on the multi-agent environment more accurate.

### BRIEF DESCRIPTION OF DRAWINGS

In order to more clearly illustrate the technical solutions in the embodiments of the present invention, the drawings to be used in the description of the embodiments will be briefly introduced below, and it is obvious that the drawings in the following description are only some embodiments of the present disclosure, and for the person of ordinary skill in the art, other drawings can be obtained according to these drawings without putting in creative labor.

FIG. 1 is a flow schematic diagram of a navigation simulation method for multi-robot provided by first embodiment of the present disclosure;

FIG. 2 is a flow schematic diagram of a navigation simulation method for multi-robot provided by second embodiment of the present disclosure;

FIG. 3 is a display schematic diagram for multi-agent simulated navigation;

FIG. 4 is a flow schematic diagram of a navigation simulation method for multi-robot provided by third embodiment of the present disclosure;

FIG. 5 is a flow schematic diagram of a navigation simulation apparatus for multi-robot provided by fourth embodiment of the present disclosure; and

FIG. 6 is a structural schematic diagram of an electronic device provided by a fifth embodiment of the present disclosure.

### DETAILED DESCRIPTION

The technical solutions in the embodiments of the present disclosure will be clearly and completely described below in conjunction with the drawings in the embodiments of the present disclosure, and it is clear that the described embodiments are only a part of the embodiments of the present disclosure and not all of the embodiments. Based on the embodiments in the present disclosure, all other embodiments obtained by a person of ordinary skill in the art without making creative labor fall within the scope of protection of the present disclosure.

It should be noted that the terms “first”, “second”, etc. in the specification and claims of the present disclosure and the above-described drawings are used to distinguish between similar objects, and need not be used to describe a particular order or sequence. It should be understood that the data so used may be interchanged, where appropriate, so that the embodiments of the present disclosure described herein can be practiced in an order other than those illustrated or described herein. In addition, the terms “comprising” and “having”, and any variations thereof, are intended to cover non-exclusive embodiments, e.g., a process, method, system, product, or server including a series of steps or units need not be limited to those clearly listed, but may include other steps or units that are not clearly listed or are inherent to those processes, methods, products, or devices.

The words “exemplary” or “for example” are used in the embodiments of the present disclosure to denote an example, illustration, or description, and those described in the embodiments of the present disclosure as “exemplary” or “for example” are not intended to be used in the embodiments of the present disclosure. Any embodiment or solution described as “exemplary” or “for example” in the embodiments of the present disclosure should not be construed as being preferred or advantageous over other embodiments or solutions. Rather, the use of the words “exemplary” or “for example” is intended to present the relevant concepts in a specific manner.

In the description of embodiments of the present disclosure, unless otherwise indicated, “plurality” means two or more, that is, at least two. “At least one” means one or more.

A multi-agent environment for mobile navigation tasks is a virtual environment created by computers or other technical means to test and optimize mobile robot navigation. The multi-agent environment can simulate or restore various complex scenarios and conditions in the real world, allowing researchers to conduct in-depth research on navigation algorithms, sensor integration, path planning and the like, without the need for actual robot hardware.

By simulating different navigation scenarios, developers may test and adjust navigation algorithms to ensure that they can provide accurate and reliable navigation services in various environments. Compared with onsite testing, the use of a multi-agent environment for navigation simulation may greatly reduce research and development costs and time. The developers may simulate different scenarios multiple times in a short period of time to quickly identify problems and make improvements.

The multi-agent environment often includes the following major components:

Scenario modeling: the multi-agent environment needs to be able to create realistic 3D scenes, both indoors and outdoors. These scenes may contain various obstacles, terrain changes, and lighting conditions to simulate the complexity of the real world.

Sensor simulation: in a navigation task, a sensor plays a vital role. The multi-agent environment needs to be able to simulate output of various sensors, such as a lidar, a camera, a depth camera, an ultrasonic sensor, and the like. These simulated data should be as close as possible to performance characteristics of real sensors in order to obtain accurate results when testing navigation algorithms.

Interaction function: the multi-agent environment should support a user to interact with a virtual robot, such as setting a start point, a target point, obstacles, etc. In addition, the user may also adjust navigation parameters, view sensor data, analyze navigation paths, and so on.

Performance evaluation: the multi-agent environment should have a performance evaluation function that can quantitatively evaluate indicators such as a completion time, a path length, and a number of collisions of a navigation task, which facilitates researchers understanding the performance of the navigation algorithms in different scenarios, so as to implement optimization and improvement.

By constructing a multi-agent environment, the developers may develop and test the mobile robot navigation technology more efficiently, reduce research and development costs, and shorten research and development cycles. In the meantime, the multi-agent environment may also provide important references for actual robot deployment and improve the navigation performance of robots in the real world.

An agent is a computer system or entity with autonomy and interactivity, which may also be understood as a virtual robot. Autonomy means that the agent can independently make plans and execute actions according to its own goals and environmental conditions without direct human intervention. Interactivity means that the agent can interact with other agents, humans or the environment to complete tasks through communication and collaboration.

The agent operates in a multi-agent environment to simulate behavior of a physical robot. For example, the agent navigates in the multi-agent environment.

A multi-agent environment with high simulation and strong scalability is crucial for exploring multi-robot navigation algorithms and establishing a complete algorithm evaluation system. At present, a multi-agent environment is often only for evaluation of a single agent. For multi-agent interaction scenarios, a multi-agent environment is often randomly generated. The randomly generated multi-agent environment lacks real data distribution, resulting in a poor simulation effect.

In order to solve the problem of the prior art, embodiments of the present disclosure provide a navigation method in a multi-agent environment. By acquiring navigation log data generated by a plurality of robots operating in a real physical environment, and constructing a multi-agent environment based on the navigation log data of the plurality of robots, the multi-agent environment constructed based on the real navigation log data is more realistic, so that execution results of multi-agent tasks based on the multi-agent environment are more accurate.

The technical solution of the present disclosure is described in detail below through some embodiments. The embodiments described below may be combined with each other, and the same or similar concepts or processes may not be repeated in some embodiments.

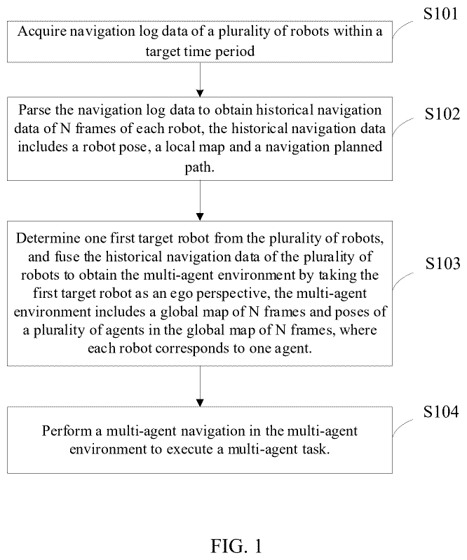

FIG. 1 is a flow schematic diagram of a navigation simulation method for multi-robot provided by first embodiment of the present disclosure. The method of the present embodiment may be executed by a simulation device, which may be a terminal or a server. The terminal device may be a mobile phone, a tablet computer, a desktop computer, a portable laptop computer, a personal digital assistant, and the like. The server may be a server cluster or a single server, and the server may be a cloud server, etc. As shown in FIG. 1, the method provided in the present embodiment includes the following steps:

S101, acquire navigation log data of a plurality of robots within a target time period.

The navigation log data includes operation log data acquired and recorded by the plurality of robots at a preset acquisition frame rate within a same time period (i.e., within the target time period), where the preset acquisition frame rate is, for example, 10, 20 or 30 frames per second. The operation log data of each robot is operation trajectory data of the robot moving and recorded in the real physical environment.

The plurality of robots are located in a same space or a same map. For example, when robots are used in a warehouse, the plurality of robots are located in a same warehouse. When robots are used in indoor spaces such as office areas, hotels, and supermarkets, the plurality of robots are located in a same indoor space. The plurality of robots move in the same space, to generate motion trajectories or operation trajectories.

The target time period may be in hours or minutes. For example, the target time period may be one or more hours, or the target time period may be 20, 30 or 60 minutes, and so on.

The operation log data of each robot includes: a robot ID, a plurality of acquisition time points, robot poses at each acquisition time point, a local map, and navigation path panning, etc.

The robot pose includes a position and an orientation. The position of the robot may be represented by 3D coordinates of the robot in the map, and the orientation of the robot may be represented by the direction it is facing.

The local map is a map area that the robot can see at a current position. For example, by taking the current position of the robot as an origin, a map area within a radius of 6 meters is the local map.

The navigation path planning may include a start point and an end point of a path, and the navigation path planning may be a path planned by an upper-layer application.

Each robot may acquire and record its own navigation log data according to log configuration information during operation, and send the navigation log data to the simulation device, which can acquire the navigation log data of the plurality of robots in the same space.

S102, parse the navigation log data to obtain historical navigation data of N frames of each robot, the historical navigation data includes a robot pose, a local map and a navigation planned path.

The navigation log data includes a plurality of frames of data. The navigation log data may be stored according to a log structure. The navigation log data may also include some data unrelated to navigation. By parsing the navigation log data, historical navigation data of N frames of each robot may be obtained. The historical navigation data includes a robot pose, a local map and a navigation planned path, each frame of the historical navigation data corresponding to a time point.

Optionally, the historical navigation data also includes a historical navigation trajectory, which is a path that the robot takes from a start point to a destination. The historical navigation trajectory includes a plurality of position points, and the position of the robot in each frame may be used as a position point of the historical navigation trajectory.

S103, determine one first target robot from the plurality of robots, and fuse the historical navigation data of the plurality of robots to obtain the multi-agent environment by taking the first target robot as an ego perspective, the multi-agent environment includes a global map of N frames and poses of a plurality of agents in the global map of N frames, where each robot corresponds to one agent.

The fusing the historical navigation data of the plurality of robots includes a map fusion and a robot pose fusion. The map fusion refers to fusing local maps of the plurality of robots into a global map to obtain a global map for each frame. The robot pose fusion refers to determining poses of the plurality of robots in the global map of each frame.

Exemplarily, the historical navigation data of each frame of the plurality of robots are aligned, and the local maps of the N frames of the plurality of robots are fused to obtain a global map of each frame. By taking a pose of the first target robot in each frame as a reference, poses of other robots in the global map are determined according to the historical navigation data of other robots, to obtain a pose of an agent corresponding to each robot in the global map.

The first target robot does not specifically refer to a certain robot in the plurality of robots. The first target robot may be any one of the plurality of robots. The simulation device selects one robot as the first target robot from among the plurality of robots, and fuses the historical navigation data of the plurality of robots by taking the first target robot as an ego perspective.

The simulation device may start fusing from a first frame of historical navigation data within the target time period according to a chronological order. The local map of each frame of the plurality of robots may or may not have interactions. When the simulation device performs a map fusion, local maps of the plurality of frames may be fused according to a preset fusion algorithm to obtain the global map of each frame. The global map is a complete map that is continuous in space, and the global map includes the local map of each robot.

Exemplarily, the fusion algorithm includes but not limited to a weighted average, a maximum likelihood estimation, Bayesian filtering, etc. The simulation device obtains the global map of each frame through the map fusion.

When the poses of the plurality of robots are fused, it is necessary to take the first target robot as the ego perspective, and the pose and time of the first target robot as an initial state or reference, to determine the poses of the other robots with respect to the first target robot at a same time, where the poses of the other robots with respect to the first target robot are poses of the other robots in the global map.

A layout map of each robot may contain some dynamic obstacles that change in real time. The dynamic obstacles are relative to static obstacles. For example, for a robot, pedestrians, animals, and vehicles in a local map are dynamic obstacles, while walls, doors, pillars, and furniture in the local map are static obstacles. The dynamic obstacles are mobile, so positions of the dynamic obstacles in the global map of each frame after the map fusion change dynamically, while positions of the static obstacles are fixed.

Through the map fusion and the robot pose fusion, a change in the global map by taking any robot as the ego perspective within any number of frames starting from any time point covered by the navigation log data, and a change in state of the robot itself, may be obtained.

S104, perform a multi-agent navigation in the multi-agent environment to execute a multi-agent task.

In an application scenario, the multi-agent environment is used to simulate and evaluate a new navigation policy, which is also called a new navigation algorithm. Exemplarily, the new navigation policy is used to replace a historical navigation policy of the target agent corresponding to a second target robot in the plurality of robots, agents corresponding to the plurality of robots are used to infer in the multi-agent environment to obtain an inference result, which includes the new navigation trajectory of the target agent and navigation trajectories of other agents. The historical navigation policy is a navigation policy used by the second target robot to generate the historical navigation data.

In the present embodiment, the multi-agent environment can simulate a situation where a plurality of robots are operating at a same time, that is, agents corresponding to the plurality of robots perform inference in the multi-agent environment at the same time. An agent corresponding to a robot may be understood as a virtual robot, which is used to replace a physical robot to operate in the multi-agent environment. The inference of an agent in the multi-agent environment may be understood as the agent operating in the environment according to the navigation policy. During operation, the agent needs to continuously calculate a next path and execute the path. A process of the agent calculating a path and executing the path may be understood as an inference.

In the present embodiment, the navigation simulation of the plurality of robots is performed by taking the agent corresponding to the second target robot as the ego perspective. The second target robot is any one of the plurality of robots, that is, the navigation policy of the agent corresponding to any one of the robots may be replaced.

The new navigation policy refers to a newly generated navigation policy for evaluation, and the historical navigation policy refers to a navigation policy used by each robot in forming navigation log data or historical navigation data.

The navigation policy (new navigation policy or historical navigation policy) may be a navigation algorithm based on rules, a navigation algorithm obtained based on Reinforcement Learning (RL), a navigation algorithm obtained based on Imitation Learning (IL), or a navigation algorithm obtained by other methods. The embodiment of the present application does not limit the method of obtaining the navigation policy.

The navigation policy is used to assist an agent in planning a navigation path so that the agent can reach a destination as quickly as possible, avoid obstacles as much as possible, or can be kept as far away from obstacles as possible.

The using a new navigation policy to replace a historical navigation policy of a target agent corresponding to a second target robot in the plurality of robots, includes: associating the target agent corresponding to the second target robot with the new navigation policy, and the target agent will use the new navigation policy for navigation after the association.

In the present embodiment, there are a plurality of agents in the multi-agent environment. In addition to the target agent corresponding to the second target robot as the ego perspective, other agents will also interact with the multi-agent environment. Interaction between the other agents and the multi-agent environment includes two modes: (1) Non-feedback mode, where the other agents use historical navigation policies to infer in the multi-agent environment; (2) Feedback mode, where the other agents use the new navigation policy to infer in the multi-agent environment.

The target agent forms a new navigation trajectory by inference in the multi-agent environment, and evaluates the new navigation policy according to the new navigation trajectory and the historical navigation trajectory of the target agent. The start point and the destination of the new navigation trajectory are same as those of the historical navigation trajectory. The historical navigation trajectory of the target agent may be obtained based on the navigation log data or the historical navigation data of the second target robot.

Optionally, during an inference process, positions of the agents corresponding to the plurality of robots in the multi-agent environment are displayed in real time, so that testers can intuitively and in real time understand the positions of each agent.

In another application scenario, a navigation policy to be trained is trained in the multi-agent environment by using a reinforcement learning method or an imitation learning method. The navigation policy to be trained may be the new navigation policy mentioned above, or other navigation policies. Exploring a new navigation policy through reinforcement learning or imitation learning can improve intelligence of navigation algorithms.

The reinforcement learning consists of two parts: the agent and the environment. In the process of reinforcement learning, the agent interacts with the environment continuously. After obtaining a certain state in the environment, the agent will use the state to output an action. The action will be executed in the environment, and the environment will output a next state and a reward brought by the current action according to the action taken by the agent. The agent aims to obtain as many rewards as possible from the environment.

The environment is used to provide state information and reward feedback, and is an external system affected by the action of the agent. The state is information for describing a current status of the environment. The action refers to an operation performed by the agent in the environment. The reward is an evaluation of the action performed by the agent by the environment, which is a scalar value.

In the navigation scenario, the action is to move to a specified position or avoid an obstacle and move to a specified position. The state of the environment may be a change of the environment. During movement of the agent, as the position of the agent changes, the state of the environment also changes. Each time the agent performs a move operation, the environment will calculate a reward corresponding to the action.

The environment may start simulated exploration with any state as an initial value. For example, the agent is set to walk randomly in the multi-agent environment. Every time the agent walks, when it encounters an obstacle, the environment will punish it once, and a negative reward may be generated as a penalty. When no obstacle is encountered, the environment will generate a positive reward. During an exploration process, the navigation policy to be trained is updated with a goal of maximizing an expected reward.

The imitation training is to train the agent to copy continuous actions of an expert, thereby achieving a purpose of imitation. In the embodiments of the present disclosure, the continuous actions of the expert are continuous historical actions corresponding to the historical navigation trajectories of each robot. In an exemplary method, a neural network is initialized. During the inference process, the neural network is used to infer a next action; however, it is not executed according to an action inferred, but according to the historical actions in the historical navigation trajectory. When parameters of the neural network are updated, the parameters of the neural network are updated with a goal of being as close to the historical actions as possible, thereby achieving a goal of imitation learning. The neural network trained by imitation learning is a navigation policy close to the historical navigation policy.

In another application scenario, in a multi-agent environment, agents corresponding to a plurality of robots perform navigation playback according to historical navigation trajectories of the plurality of robots; that is, the agent corresponding to each robot executes the historical actions of each robot in the multi-agent environment according to the historical actions corresponding to the historical navigation trajectory of each robot, so as to implement playback of the navigation process of each robot. Reproducibility of the historical state of each robot is achieved through a navigation playback, which can provide a fair benchmark for performance evaluations of different methods. According to the historical state of each robot, the testers may find bad cases, troubleshoot problems, optimize policies, and so on.

In the present embodiment, it is implemented by acquiring navigation log data of a plurality of robots within a target time period, parsing the navigation log data to obtain historical navigation data of N frames of each robot, the historical navigation data including a robot pose, a local map and a navigation planned path; determining one first target robot from the plurality of robots, and fusing the historical navigation data of the plurality of robots to obtain the multi-agent environment by taking the first target robot as an ego perspective, the multi-agent environment including a global map of N frames and poses of a plurality of agents in the global map of N frames, where each robot corresponds to one agent; and performing a multi-agent navigation in the multi-agent environment to execute a multi-agent task. In the method, the multi-agent environment of a plurality of robots is constructed based on actual navigation logs of a large number of robots. The multi-agent environment is generated based on real data, so that authenticity of the constructed multi-agent environment is higher, thereby causing the execution results of the multi-agent tasks based on the multi-agent environment more accurate.

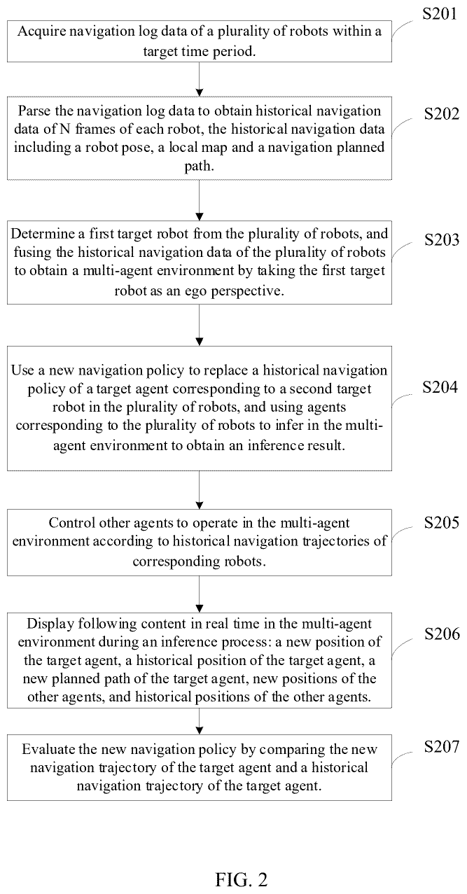

FIG. 2 is a flow schematic diagram of a navigation simulation method for multi-robot provided by second embodiment of the present disclosure, which is mainly used to simulate and evaluate a new navigation policy. As shown in FIG. 2, the method provided in the present embodiment includes the following steps:

S201, acquire navigation log data of a plurality of robots within a target time period.

S202, parse the navigation log data to obtain historical navigation data of N frames of each robot, the historical navigation data including a robot pose, a local map and a navigation planned path.

S203, determine a first target robot from the plurality of robots, and fusing the historical navigation data of the plurality of robots to obtain a multi-agent environment by taking the first target robot as an ego perspective.

The multi-agent environment includes a global map of N frames and poses of a plurality of agents in the global map of N frames, where each robot corresponds to an agent.

For specific implementations of the S201-S203, please refer to a relevant description of the first embodiment, which will not be repeated here.

S204, use a new navigation policy to replace a historical navigation policy of a target agent corresponding to a second target robot in the plurality of robots, and using agents corresponding to the plurality of robots to infer in the multi-agent environment to obtain an inference result.

The initial value of the target agent is used as the input of the new navigation policy. The initial value includes inference start time, an inference start position and a destination. The target agent starts operation from the inference start time, and the start time of the operation is the inference state time. The new navigation policy is used for navigation during the operation process.

The inference start time may be any time point within the target time period, which may be represented by a specific time value or by a frame number corresponding to the time point. For example, when the target time period is 6:00-8:00 on April 25, then the start time point is any time point between 6:00 and 8:00. Assuming that 2000 frames of historical navigation data are acquired between 6:00 and 8:00, the 2000 frames of historical navigation data may be numbered in a chronological order, and the inference start time may be determined according to the frame number.

The target agent may perform inference at preset time intervals, for example, once per second or once per frame.

The target agent uses the new navigation policy and the multi-agent environment to perform a step of inference, to obtain a navigation position after each step of inference, and control the target agent to move to the navigation position. Finally, navigation positions after M consecutive steps of inference form a new navigation trajectory of the target agent.

Assuming that the target agent infers once per frame, starts inference in a first frame, and takes the pose, frame number and destination of the target agent in the first frame as the input of the new navigation policy. The new navigation policy infers a navigation position of the target agent in a second frame based on the input, and controls the target agent to move to the navigation position of the second frame. Then, the navigation position, frame number and destination of the second frame are used as input of a next inference, to infer a navigation position of the target agent in a third frame, and so forth accordingly, to obtain the navigation position of the target agent in each frame. The navigation position of the target agent in each frame refers to a position of the target agent in a global map of each frame of the multi-agent environment.

S205, control other agents to operate in the multi-agent environment according to historical navigation trajectories of corresponding robots.

The other agents are agents corresponding to remaining robots in the plurality of robots except the second target robot. Assuming that navigation log data of 10 robots are obtained, the multi-agent environment may perform navigation simulation for the 10 robots at a same time. Assuming that only a historical navigation policy of one robot is replaced, there are 9 other agents in the multi-agent environment except the agent of the ego perspective. For each of the 9 agents, each agent is controlled to operate in the multi-agent environment according to a historical navigation trajectory of a corresponding robot.

In the present embodiment, an interaction mode between the other agents and the multi-agent environment is a non-feedback mode, that is, the other agents use historical navigation policies to infer in the multi-agent environment, and the other agents strictly follow the historical navigation trajectories and will not generate new feedback on the behavior of the agent in the ego perspective.

For example, an agent 1 is the ego perspective. In the historical navigation data, there is no collision between the agent 1 and an agent 2 at a time t. After the agent 1 uses the new navigation policy for inference, at the time t, the agent 1 moves according to a navigation position planned by the new navigation policy, and the agent 2 still moves according to the historical navigation trajectory, resulting in a collision between the agent 1 and the agent 2 at the time t. In the no-feedback mode, the agent 2 does not generate new feedback for the new collision behavior, that is, the new collision behavior will not change a historical navigation trajectory of the agent 2, and the agent 2 still operates according to the historical navigation trajectory.

S206, display following content in real time in the multi-agent environment during an inference process: a new position of the target agent, a historical position of the target agent, a new planned path of the target agent, new positions of the other agents, and historical positions of the other agents.

The new position is a position inferred according to the new navigation policy, the historical position is a position indicated by the historical navigation data at a same time, and the new planned path is a path inferred according to the new navigation policy.

A simulation device may visualize a dynamically changing global map and real-time changing positions of all robots in a frame-by-frame playback mode, so that the testers can intuitively and instantly understand the positions of the robots. By comparing the new position and the historical position of the target agent at the same time, the testers can intuitively see a difference between inference results of the new navigation policy and the historical navigation policy.

Exemplarily, the new position of the target agent may be represented by a rectangle with a solid line, the historical position of the target agent may be represented by a rectangle with dot-and-dash line, the historical position of other agents may be represented by a rectangle with a dashed line, and the new planned path of the target agent may be represented by a bold line.

Optionally, an identity or a serial number of each agent is displayed at the position of the agent, so that the user can distinguish between different agents.

It is understood that this is just an example, and the new position and the historical position of the target agent and the historical positions of the other agents may also be displayed differently in other ways.

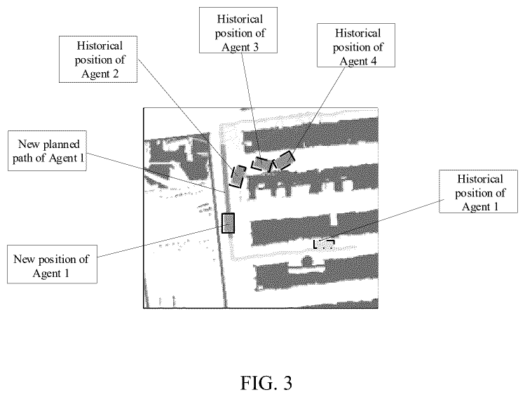

Referring to FIG. 3, FIG. 3 is a display schematic diagram for multi-agent simulated navigation. As shown in FIG. 3, the multi-agent environment includes agents of 4 robots, and an agent 1 is a target agent, i.e., an ego agent. The new position, historical position and new planned path of the agent 1, as well as the historical positions of the other three agents, are displayed in the multi-agent environment.

S207, evaluate the new navigation policy by comparing the new navigation trajectory of the target agent and a historical navigation trajectory of the target agent.

The new navigation trajectory is a path planned according to the new navigation policy, and the historical navigation trajectory is a path planned according to the historical navigation policy, where the start point and destination of the new navigation trajectory and the historical navigation trajectory are the same. The new navigation trajectory is compared with the historical navigation trajectory to evaluate quality of the new navigation policy.

Exemplarily, a navigation duration, a path length, a number of collisions and other indicators of the new navigation trajectory and the historical navigation trajectory are compared to evaluate the new navigation policy. The navigation duration refers to time required to complete a navigation task, that is, time required from the start point to the destination, and the path length refers to a distance of the road that the navigation trajectory goes along.

In an implementation, when the navigation duration corresponding to the new navigation trajectory is less than the navigation duration corresponding to the historical navigation trajectory, and the path length corresponding to the new navigation trajectory is less than or similar to the path length corresponding to the historical navigation trajectory, the new navigation policy is considered to be superior to the historical navigation policy.

In the present embodiment, performance indicators of a single agent may be compared more fairly through the non-feedback mode. Optionally, the historical navigation policies of the plurality of agents may be replaced in sequence, and the new navigation policy may be evaluated according to the inference results of the plurality of agents.

In the present embodiment, by replacing the historical navigation policy of the target agent with a new navigation policy, the target agent uses the new navigation policy to perform an M-step inference in a multi-agent environment to obtain a new navigation trajectory of the target agent. In the meantime, other agents operate in the multi-agent environment according to the historical navigation trajectory of the corresponding robot, evaluate the new navigation policy by comparing the new navigation trajectory and the historical navigation trajectory of the target agent. The method can replace the historical navigation policy of any robot with any new navigation policy for simulation evaluation, causing the evaluation of navigation simulation of the plurality of robots more flexible.

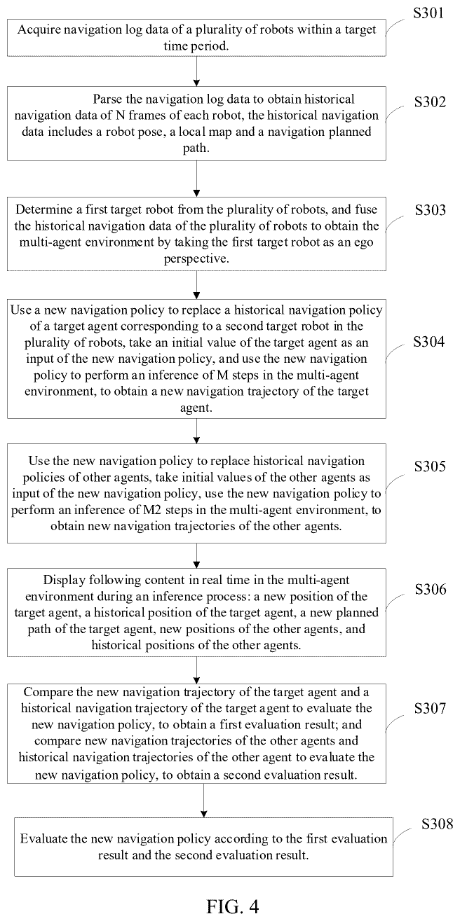

FIG. 4 is a flow schematic diagram of a navigation simulation method for multi-robot provided by third embodiment of the present disclosure, which is mainly used to simulate and evaluate a new navigation policy. As shown in FIG. 4, the method provided in the present embodiment includes the following steps:

S301, acquire navigation log data of a plurality of robots within a target time period.

S302, parse the navigation log data to obtain historical navigation data of N frames of each robot, the historical navigation data includes a robot pose, a local map and a navigation planned path.

S303, determine a first target robot from the plurality of robots, and fuse the historical navigation data of the plurality of robots to obtain the multi-agent environment by taking the first target robot as an ego perspective.

The multi-agent environment includes a global map of N frames and poses of a plurality of agents in the global map of N frames, where each robot corresponds to an agent.

For specific implementations of S301-S303, please refer to a relevant description of the first embodiment, which will not be repeated here.

S304, use a new navigation policy to replace a historical navigation policy of a target agent corresponding to a second target robot in the plurality of robots, take an initial value of the target agent as an input of the new navigation policy, and use the new navigation policy to perform an inference of M steps in the multi-agent environment, to obtain a new navigation trajectory of the target agent.

The initial value of the target agent includes inference start time, an inference start position and a destination. For specific implementation of S304, please refer to a relevant description of S204 in the second embodiment, which will not be repeated here.

S305, use the new navigation policy to replace historical navigation policies of other agents, take initial values of the other agents as input of the new navigation policy, use the new navigation policy to perform an inference of M2 steps in the multi-agent environment, to obtain new navigation trajectories of the other agents.

The initial values of the other agents include inference start time, an inference start position and a destination. The inference start time of the target agent and that of the other agents may be same or different. For example, an agent 1 is a target agent, and the agent 1 starts inference at a 0-th frame, an agent 2 starts inference at a 10-th frame, and other agent start inference at a 50-th frame.

M1 and M2 may be same or different, and the number of inference steps is related to the inference start position and destination of the agent.

In the present embodiment, an interaction mode between the other agents and the multi-agent environment is a feedback mode, that is, the other agents all use the new navigation policy to infer in the multi-agent environment. In the present embodiment, the agents of the plurality of robots all adopt the new navigation policy to perform simulated navigation in the multi-agent environment at a same time, so that the new navigation policy can be evaluated in the multi-agent environment.

The non-feedback mode and the feedback mode each have their own advantages and disadvantages. The non-feedback mode may compare the performance indicators of a single agent more fairly, but it ignores the problem of possible game problems between agents. Although the feedback mode can effectively evaluate the historical navigation policies in the case of a plurality of agents, a distortion of the policy adopted by the agents may cause a cumulative error of the entire environment to increase, thereby affecting the evaluation of the single agent on the historical navigation policy.

S306, display following content in real time in the multi-agent environment during an inference process: a new position of the target agent, a historical position of the target agent, a new planned path of the target agent, new positions of the other agents, and historical positions of the other agents.

The new position is a position inferred according to the new navigation policy, the historical position is a position indicated by the historical navigation data at a same time, and the new planned path is a path inferred according to the new navigation policy.

Optionally, in order to avoid displaying too cluttered content, the historical positions of other agents may not be displayed.

S307, compare the new navigation trajectory of the target agent and a historical navigation trajectory of the target agent to evaluate the new navigation policy, to obtain a first evaluation result; and compare new navigation trajectories of the other agents and historical navigation trajectories of the other agent to evaluate the new navigation policy, to obtain a second evaluation result.

In the present embodiment, for a plurality of agents in a multi-agent environment, it is necessary to compare their new navigation trajectories with their historical navigation trajectories, and the new navigation strategy may be evaluated based on indicators such as a navigation duration, a path length, and a number of collisions of the new navigation trajectory and the historical navigation trajectory.

S308, evaluate the new navigation policy according to the first evaluation result and the second evaluation result.

The new navigation policy is evaluated by integrating evaluation results of the plurality of agents, which is closer to the real scene because it takes into account possible game problems between the plurality of agents.

In the present embodiment, the historical navigation policies of the agents corresponding to the plurality of robots in the multi-agent environment are replaced with the new navigation policy, and the plurality of agents simultaneously use the new navigation policy to perform inference of a plurality of steps in the multi-agent environment to obtain a new navigation trajectory of each agent. The new navigation policy is evaluated by comparing the new navigation trajectory with the historical navigation trajectory of each agent, and the new navigation policy is comprehensively evaluated based on the evaluation results of the plurality of agents.

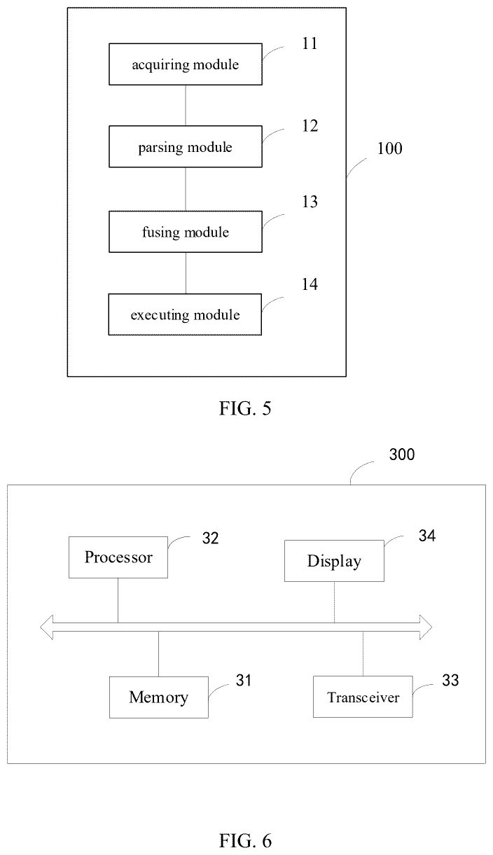

To facilitate better implementations of the navigation method in the multi-agent environment of the embodiments of the present disclosure, the embodiments of the present disclosure also provide a navigation apparatus in a multi-agent environment. FIG. 5 is a flow schematic diagram of a navigation simulation apparatus for multi-robot provided by fourth embodiment of the present disclosure, as shown in FIG. 5, the navigation apparatus 100 in the multi-agent environment may include:
an acquiring module 11, which is configured to acquire navigation log data of a plurality of robots within a target time period;
a parsing module 12, which is configured to parse the navigation log data to obtain historical navigation data of N frames of each robot, the historical navigation data including a robot pose, a local map and a navigation planned path;
a fusing module 13, which is configured to determine one first target robot from the plurality of robots, and fuse the historical navigation data of the plurality of robots to obtain the multi-agent environment by taking the first target robot as an ego perspective, the multi-agent environment including a global map of N frames and poses of a plurality of agents in the global map of N frames, where each robot corresponds to one agent;
an executing module 14, which is configured to perform a multi-agent navigation in the multi-agent environment to execute a multi-agent task.

In one implementation, the executing module 14 is specifically configured to:
use a new navigation policy to replace a historical navigation policy of a target agent corresponding to a second target robot in the plurality of robots, and using agents corresponding to the plurality of robots to infer in the multi-agent environment to obtain an inference result, the inference result including a new navigation trajectory of the target agent, and the historical navigation policy being a navigation policy used by the second target robot to generate the historical navigation data.

In one implementation, the executing module 14 is specifically configured to:
take an initial value of the target agent as an input of the new navigation policy, use the new navigation policy to perform an inference of M steps in the multi-agent environment, to obtain the new navigation trajectory of the target agent, the initial value of the target agent including inference start time, an inference start position and a destination; and
control other agents to operate in the multi-agent environment according to historical navigation trajectories of corresponding robots, where the other agents are agents corresponding to remaining robots in the plurality of robots except the second target robot.

In one implementation, the apparatus further includes:
an displaying module, configured to, display following content in real time in the multi-agent environment during an inference process: a new position of the target agent, a historical position of the target agent, a new planned path of the target agent, and historical positions of the other agents, where the new position is a navigation position inferred according to the new navigation policy, the historical position is a position indicated by the historical navigation data at a same time, and the new planned path is a path inferred according to the new navigation policy.

In one implementation, the executing module 14 is specifically configured to:
take an initial value of the target agent as an input of the new navigation policy, use the new navigation policy to perform an inference of M1 steps in the multi-agent environment, to obtain the new navigation trajectory of the target agent, the initial value of the target agent including inference start time, an inference start position and a destination; and
use the new navigation policy to replace historical navigation policies of other agents, take initial values of the other agents as input of the new navigation policy, use the new navigation policy to perform an inference of M2 steps in the multi-agent environment, to obtain new navigation trajectories of the other agents, the initial values of the other agents including inference start time, an inference start position and a destination.

In one implementation, the apparatus further includes:
a displaying module, configured to, display following content in real time in the multi-agent environment during an inference process: a new position of the target agent, a historical position of the target agent, a new planned path of the target agent, new positions of the other agents, and historical positions of the other agents, where the new position is a position inferred according to the new navigation policy, the historical position is a position indicated by the historical navigation data at a same time, and the new planned path is a path inferred according to the new navigation policy.

In one implementation, the executing module 14 is specifically configured to: train a navigation policy to be trained in the multi-agent environment by using a reinforcement learning method or an imitation learning method.

In one implementation, the executing module 14 is specifically configured to:
perform navigation playback by the agents corresponding to the plurality of robots according to historical navigation trajectories of the plurality of robots in the multi-agent environment.

In one implementation, the fusing module 13 is specifically configured to:
align historical navigation data of each frame of the plurality of robots;
fuse local maps of N frames of the plurality of robots to obtain a global map of each frame; and
determine poses of other robots in the global map according to historical navigation data of the other robots by taking a pose of the first target robot in the global map of each frame as a reference.

In one implementation, the new navigation policy is a policy obtained by a reinforcement learning method or an imitation learning method.

In one implementation, the apparatus further includes:
a displaying module, configured to, display, in real time, positions of the agents corresponding to the plurality of robots in the multi-agent environment during an inference process.

In one implementation, the apparatus further includes an evaluating module, which is configured to:
compare the new navigation trajectory of the target agent and a historical navigation trajectory of the target agent to evaluate the new navigation policy, to obtain a first evaluation result;
compare new navigation trajectories of the other agents and historical navigation trajectories of the other agent to evaluate the new navigation policy, to obtain a second evaluation result; and
evaluate the new navigation policy according to the first evaluation result and the second evaluation result.

The apparatus of the present embodiment may be used to perform any of the methods described in the above first embodiment to third embodiment, and the specific implementation is described with reference to the method embodiments and will not be repeated herein.

It should be understood that the apparatus embodiments and the method embodiments may correspond to each other, and similar descriptions may refer to the method embodiments. In order to avoid repetition, it will not be repeated herein.

The apparatus 100 of the embodiments of the present disclosure is described above in connection with the drawings from the perspective of a functional module. it should be understood that the functional module may be realized in the form of hardware, in the form of instructions in the form of software, or in the form of a combination of hardware and software modules. Specifically, the steps of the method embodiments of the present disclosure may be accomplished by integrated logic circuits of hardware in the processor and/or instructions in the form of software, and the steps of the method in conjunction with the method disclosed in the embodiments of the present disclosure may be directly embodied as accomplished by execution of a hardware decoding processor or accomplished by execution with a combination of hardware and software modules in the decoding processor. Optionally, the software module may be located in a random memory, flash memory, read-only memory, programmable read-only memory, electrically erasable programmable memory, registers, and other storage media well established in the art. The storage medium is located in the memory, and the processor reads the information in the memory and completes the steps in the above method embodiments in combination with its hardware.

The embodiments of the present disclosure provide an electronic device. FIG. 6 is a structural schematic diagram of an electronic device provided by a fifth embodiment of the present disclosure. Referring to FIG. 6, the electronic device 300 may include:
a memory 31 and a processor 32, the memory 31 being used to store a computer program and transmit such program code to the processor 32. In other words, the processor 32 may call up and run the computer program from the memory 31 to implement the navigation simulation method for multi-robot provided by embodiments of the present application.

For example, the processor 32 may be used to execute the navigation simulation method for multi-robot provided by the method embodiments described above according to instructions in the computer program.

In some embodiments of the present disclosure, the processor 32 may include, but is not limited to: a general-purpose processor, a Digital Signal Processor (DSP), an Application Specific Integrated Circuit (ASIC), a Field Programmable Gate Array (Field Programmable Gate Array (FPGA) or other programmable logic device, discrete gate or transistor logic device, discrete hardware components, and the like.

In some embodiments of the present disclosure, the memory 31 includes, but is not limited to: volatile memory and/or non-volatile memory. The non-volatile memory may be Read-Only Memory (ROM), Programmable ROM (PROM), Erasable Programmable Read-Only Memory (EPROM), Electrically Erasable Programmable Read-Only Memory (EEPROM) or flash memory. The volatile memory may be Random Access Memory (RAM), which is used as an external cache. By way of illustration, but not limitation, many forms of RAM are available, such as Static RAM (SRAM), Dynamic RAM (DRAM), Synchronous DRAM (SDRAM), Double Data Rate SDRAM (DDR SDRAM), Enhanced Synchronous Dynamic Random Access Memory (ESDRAM), Synchronous Link DRAM (SLDRAM), and Direct Rambus Random Access Memory (DR RAM).

In some embodiments of the present disclosure, the computer program may be partitioned into one or more modules, the one or more modules being stored in the memory 31 and executed by the processor 32 to accomplish the methods provided herein. The one or more modules may be a series of computer program instruction segments capable of accomplishing a particular function, which instruction segments are used to describe the process of execution of the computer program in the electronic device.

As shown in FIG. 6, the electronic device 300 may further include: a transceiver 33, a display 34, and the like. The processor 32 is electrically connected to the transceiver 33 and the display 34, respectively.

The processor 32 may control the transceiver 33 to communicate with other devices, specifically, to send information or data to other devices, or to receive information or data sent by other devices. The transceiver 33 may include a transmitter and a receiver. The transceiver 33 may further include an antenna, and the number of antennas may be one or more.

The display 34 may be used to display a graphical user interface as well as to receive operational commands generated by a user acting on the graphical user interface. The display 34 may be a touchscreen display, and the touchscreen display may include a display panel and a touch panel. The display panel may be used to display information entered by or provided to the user as well as various graphical user interfaces of the computer device, which may include graphics, text, icons, video, and any combination thereof. Optionally, the display panel may be configured in the form of a liquid crystal display (LCD, Liquid Crystal Display), an organic light-emitting diode (OLED, Organic Light-Emitting Diode), or the like. The touch panel may be used to collect a user's touch operation on or near it (e.g., a user's operation on or near the touch panel using a finger, a stylus, or any other suitable object or accessory) and generate a corresponding operation instruction, and the operation instruction executes a corresponding program. Optionally, the touch panel may include two parts, a touch detection device and a touch controller. The touch detection device detects the touch orientation of the user and detects the signal brought about by the touch operation, and transmits the signal to the touch controller; the touch controller receives the touch information from the touch detection device and converts it into the contact coordinates, which are then sent to the processor 32, and is able to receive the commands sent by the processor 32 and execute them. The touch panel may cover a display panel, and when the touch panel detects a touch operation on or near it, it transmits it to the processor 32 to determine the type of touch event, and the processor 32 subsequently provides a corresponding visual output on the display panel based on the type of touch event.

It will be appreciated that the structure of the electronic device illustrated in FIG. 6 does not constitute a limitation of the electronic device, and may include more or fewer components than illustrated, or a combination of certain components, or a different arrangement of components. For example, the electronic device 300 may also include a camera module, a wireless fidelity WIFI module, a positioning module, a Bluetooth module, a display, a controller, and the like, which will not be described herein.

It should be understood that the various components in the electronic device are connected via a bus system, where the bus system includes a power bus, a control bus, and a status signal bus, in addition to a data bus.

The present disclosure also provides a computer storage medium having stored thereon a computer program which, when executed by a computer, causes the computer to be capable of executing the method of the method embodiment described above. Alternatively, embodiments of the present disclosure further provide a computer program product including instructions which when executed by a computer cause the computer to perform the method of navigational simulation for multi-robot provided by the above method embodiments.

The present disclosure also provides a computer program product including a computer program that is stored in a computer-readable storage medium. A processor of the electronic device reads the computer program from the computer-readable storage medium, and the processor executes the computer program such that the electronic device performs a corresponding process of the navigation simulation method for multi-robot provided by the method embodiments, which is not described herein for brevity.

In the several embodiments provided in the present disclosure, it should be understood that the systems, apparatuses and methods disclosed, may be realized in other ways. For example, the apparatus embodiments described above are merely schematic, e.g., the division of the module, which is merely a logical functional division, may be divided in other ways when actually implemented, e.g., multiple modules or components may be combined or may be integrated into another system, or some features may be ignored, or not implemented. At another point, the mutual coupling or direct coupling or communication connection shown or discussed may be an indirect coupling or communication connection through some interface, device or module, which may be electrical, mechanical or otherwise.

The modules illustrated as separate components may or may not be physically separate, and the components shown as modules may or may not be physical modules, i.e., they may be located in a single place or may also be distributed over a plurality of network units. Some or all of these modules may be selected to fulfill the purpose of the embodiment scheme according to actual needs. For example, the various functional modules in various embodiments of the present application may be integrated in a single processing module, or each module may be physically present separately, or two or more modules may be integrated in a single module.

The above are only specific embodiments of the present disclosure, but the scope of protection of the present disclosure is not limited thereto, and any person skilled in the art who is familiar with the technical field can readily think of changes or substitutions within the scope of the technology disclosed in the present disclosure, which shall be covered by the scope of protection of the present disclosure. Therefore, the scope of protection of this disclosure shall be subject to the scope of protection of the claims.

1. A navigation method in a multi-agent environment, comprising:
acquiring navigation log data of a plurality of robots within a target time period;
parsing the navigation log data to obtain historical navigation data of N frames of each robot, the historical navigation data comprising a robot pose, a local map and a navigation planned path;
determining one first target robot from the plurality of robots, and fusing the historical navigation data of the plurality of robots to obtain the multi-agent environment by taking the first target robot as an ego perspective, the multi-agent environment comprising a global map of N frames and poses of a plurality of agents in the global map of N frames, wherein each robot corresponds to one agent; and
performing a multi-agent navigation in the multi-agent environment to execute a multi-agent task.

2. The method according to claim 1, wherein the performing a multi-agent navigation in the multi-agent environment to execute a multi-agent task, comprises:
using a new navigation policy to replace a historical navigation policy of a target agent corresponding to a second target robot in the plurality of robots, and using agents corresponding to the plurality of robots to infer in the multi-agent environment to obtain an inference result, the inference result comprising a new navigation trajectory of the target agent, and the historical navigation policy being a navigation policy used by the second target robot to generate the historical navigation data.

3. The method according to claim 2, wherein the using agents corresponding to the plurality of robots to infer in the multi-agent environment to obtain an inference result, comprises:
taking an initial value of the target agent as an input of the new navigation policy, using the new navigation policy to perform an inference of M steps in the multi-agent environment, to obtain the new navigation trajectory of the target agent, the initial value of the target agent comprising inference start time, an inference start position and a destination; and
controlling other agents to operate in the multi-agent environment according to historical navigation trajectories of corresponding robots, wherein the other agents are agents corresponding to remaining robots in the plurality of robots except the second target robot.

4. The method according to claim 3, further comprising:
displaying following content in real time in the multi-agent environment during an inference process: a new position of the target agent, a historical position of the target agent, a new planned path of the target agent, and historical positions of the other agents, wherein the new position is a navigation position inferred according to the new navigation policy, the historical position is a position indicated by the historical navigation data at a same time, and the new planned path is a path inferred according to the new navigation policy.

5. The method according to claim 2, wherein the using agents corresponding to the plurality of robots to infer in the multi-agent environment to obtain an inference result, comprises:
taking an initial value of the target agent as an input of the new navigation policy, using the new navigation policy to perform an inference of M1 steps in the multi-agent environment, to obtain the new navigation trajectory of the target agent, the initial value of the target agent comprising inference start time, an inference start position and a destination; and
using the new navigation policy to replace historical navigation policies of other agents, taking initial values of the other agents as input of the new navigation policy, using the new navigation policy to perform an inference of M2 steps in the multi-agent environment, to obtain new navigation trajectories of the other agents, the initial values of the other agents comprising inference start time, an inference start position and a destination.

6. The method according to claim 5, further comprising:
displaying following content in real time in the multi-agent environment during an inference process: a new position of the target agent, a historical position of the target agent, a new planned path of the target agent, new positions of the other agents, and historical positions of the other agents, wherein the new position is a position inferred according to the new navigation policy, the historical position is a position indicated by the historical navigation data at a same time, and the new planned path is a path inferred according to the new navigation policy.

7. The method according to claim 1, wherein the performing a multi-agent navigation in the multi-agent environment to execute a multi-agent task, comprises:
training a navigation policy to be trained in the multi-agent environment by using a reinforcement learning method or an imitation learning method.

8. The method according to claim 1, wherein the performing a multi-agent navigation in the multi-agent environment to execute a multi-agent task, comprises:
performing navigation playback by the agents corresponding to the plurality of robots according to historical navigation trajectories of the plurality of robots in the multi-agent environment.

9. The method according to claim 1, wherein the fusing the historical navigation data of the plurality of robots to obtain the multi-agent environment by taking the first target robot as an ego perspective, comprises:
aligning historical navigation data of each frame of the plurality of robots;
fusing local maps of N frames of the plurality of robots to obtain a global map of each frame; and
determining poses of other robots in the global map according to historical navigation data of the other robots by taking a pose of the first target robot in the global map of each frame as a reference.

10. The method according to claim 2, wherein the new navigation policy is a policy obtained by a reinforcement learning method or an imitation learning method.

11. The method according to claim 2, further comprising:
displaying, in real time, positions of the agents corresponding to the plurality of robots in the multi-agent environment during an inference process.

12. The method according to claim 2, further comprising:
evaluating the new navigation policy by comparing the new navigation trajectory of the target agent and a historical navigation trajectory of the target agent.

13. The method according to claim 5, further comprising:
comparing the new navigation trajectory of the target agent and a historical navigation trajectory of the target agent to evaluate the new navigation policy, to obtain a first evaluation result;
comparing new navigation trajectories of the other agents and historical navigation trajectories of the other agent to evaluate the new navigation policy, to obtain a second evaluation result; and
evaluating the new navigation policy according to the first evaluation result and the second evaluation result.

14. An electronic device, comprising:
at least one processor and a memory, wherein the memory is configured to store a computer program, and the at least one processor is configured to invoke and run the computer program stored in the memory to implement a navigation method in a multi-agent environment, and the method comprises:
acquiring navigation log data of a plurality of robots within a target time period;
parsing the navigation log data to obtain historical navigation data of N frames of each robot, the historical navigation data comprising a robot pose, a local map and a navigation planned path;
determining one first target robot from the plurality of robots, and fusing the historical navigation data of the plurality of robots to obtain the multi-agent environment by taking the first target robot as an ego perspective, the multi-agent environment comprising a global map of N frames and poses of a plurality of agents in the global map of N frames, wherein each robot corresponds to one agent; and
performing a multi-agent navigation in the multi-agent environment to execute a multi-agent task.

15. The electronic device according to claim 14, wherein the performing a multi-agent navigation in the multi-agent environment to execute a multi-agent task, comprises:
using a new navigation policy to replace a historical navigation policy of a target agent corresponding to a second target robot in the plurality of robots, and using agents corresponding to the plurality of robots to infer in the multi-agent environment to obtain an inference result, the inference result comprising a new navigation trajectory of the target agent, and the historical navigation policy being a navigation policy used by the second target robot to generate the historical navigation data.

16. The electronic device according to claim 15, wherein the using agents corresponding to the plurality of robots to infer in the multi-agent environment to obtain an inference result, comprises:
taking an initial value of the target agent as an input of the new navigation policy, using the new navigation policy to perform an inference of M steps in the multi-agent environment, to obtain the new navigation trajectory of the target agent, the initial value of the target agent comprising inference start time, an inference start position and a destination; and
controlling other agents to operate in the multi-agent environment according to historical navigation trajectories of corresponding robots, wherein the other agents are agents corresponding to remaining robots in the plurality of robots except the second target robot.

17. The electronic device according to claim 16, further comprising:
displaying following content in real time in the multi-agent environment during an inference process: a new position of the target agent, a historical position of the target agent, a new planned path of the target agent, and historical positions of the other agents, wherein the new position is a navigation position inferred according to the new navigation policy, the historical position is a position indicated by the historical navigation data at a same time, and the new planned path is a path inferred according to the new navigation policy.

18. The electronic device according to claim 15, wherein the using agents corresponding to the plurality of robots to infer in the multi-agent environment to obtain an inference result, comprises:
taking an initial value of the target agent as an input of the new navigation policy, using the new navigation policy to perform an inference of M1 steps in the multi-agent environment, to obtain the new navigation trajectory of the target agent, the initial value of the target agent comprising inference start time, an inference start position and a destination; and
using the new navigation policy to replace historical navigation policies of other agents, taking initial values of the other agents as input of the new navigation policy, using the new navigation policy to perform an inference of M2 steps in the multi-agent environment, to obtain new navigation trajectories of the other agents, the initial values of the other agents comprising inference start time, an inference start position and a destination.

19. The electronic device according to claim 18, further comprising:
displaying following content in real time in the multi-agent environment during an inference process: a new position of the target agent, a historical position of the target agent, a new planned path of the target agent, new positions of the other agents, and historical positions of the other agents, wherein the new position is a position inferred according to the new navigation policy, the historical position is a position indicated by the historical navigation data at a same time, and the new planned path is a path inferred according to the new navigation policy.

20. A non-transitory computer-readable storage medium, configured to store a computer program, the computer program causing a computer to execute a navigation method in a multi-agent environment, and the method comprises:
acquiring navigation log data of a plurality of robots within a target time period;
parsing the navigation log data to obtain historical navigation data of N frames of each robot, the historical navigation data comprising a robot pose, a local map and a navigation planned path;
determining one first target robot from the plurality of robots, and fusing the historical navigation data of the plurality of robots to obtain the multi-agent environment by taking the first target robot as an ego perspective, the multi-agent environment comprising a global map of N frames and poses of a plurality of agents in the global map of N frames, wherein each robot corresponds to one agent; and
performing a multi-agent navigation in the multi-agent environment to execute a multi-agent task.
